(19) United States
(12) Patent Application Publication
(10) Pub. No.: US 2004/0156693 A1
(43) Pub. Date: Aug. 12, 2004

(54) Locking device for a nut or bolt and an installation device

(76) Inventors: Ari Paakko, Kiuruvesi (FI); Martti Huttunen, Iisalmi (FI)

Correspondence Address: Fildes & Outland, Suite 2, 20916 Mack Avenue, Grosse Pointe Woods, MI, 48236, US

(21) Appl. No.: 10/480,133

(22) PCT Filed: Jun. 11, 2002
(86) PCT No.: PCT/FI02/00502

(30) Foreign Application Priority Data
Jun. 13, 2001 (FI) 20015013
Aug. 10, 2001 (FI) 20015019

(51) Int. Cl. F16B 39/02

(52) U.S. Cl. 411/102

(57) ABSTRACT

This invention relates to a locking device for nut/bolts, which is a locking assembly to be positioned between at least two nuts/bolts, to which have been fitted at least two brackets equipped with an inner race polygon, to the outer periphery of which has been fitted a fastening cam for the spring element to be fitted between the brackets. There are at least two of the fastening cams on the brackets and the locking device is fitted to be formed of at least three brackets chained with each other by spring elements, of which at least one is furnished to tighten the nut/bolt of the target of fastening symmetrically. Further, the invention applies also to the installation device for the locking device.

The present invention relates to a locking device for nuts/bolts that is a locking assembly to be positioned between at least two nuts/bolts, to which have been fitted at least two brackets equipped with an inner race polygon, to the outer periphery of which has been fitted a fastening cam for the spring element to be fitted between the brackets. The invention applies also to the installation device for the locking device.

The device used for locking a wheel is usually either a nut screwed at the end of a stud bolt or a bolt that goes through the wheel. From here onwards, nut stands also for the corresponding bolt-fixing and vice versa.

The loosening of wheels of heavy vehicles is a serious problem to road safety. Even today a significant amount of the occurring accidents are due to the slackening or the loosening of the nuts of a wheel of a bus or a truck, as a consequence of which the wheel comes off the axle hub and causes serious danger situations.

The loosening of wheels constitutes, in addition to the road safety problem, important expense drains to the traffic contractor in several regards, because the loosening of a wheel caused by the slackening of a nut almost invariably damages also the axle hub structures. Further, the transfer of the possible load to another vehicle, taking the vehicle to be repaired, retrieving the wheel from the terrain and the time spent repairing the vehicle are only a few examples of the encumbrances it causes to the traffic contractor.

In practice, the driver should check the tightness of the bolts at regular intervals. This is, however, quite laborious, since every wheel can contain 10 nuts and the number of wheels per vehicle can be large. It is not possible to detect the slackening directly by looking at the nut or the bolt.

Further, the slackening of nuts and bolts causes problems, in addition to the said heavy vehicles, also in industry, the machines of which abound with nut and bolt fixings. There are vibrations and trembling in the machines that slacken the nuts. The fixing points may be situated in places where checking their tightness is at the very least laborious if not even impossible. This sort of industrial machines are for example papermaking, metal working and printing machines.

From numerous publications WO-98/31554, JP-615001, GB-2260177, GB-2330637, U.S. Pat. No. 5,174,702, SE-466537 and U.S. Pat. No. 4,657,457 are known different nut locking devices and slackening detectors. They do not, however, function satisfyingly and they are also often disposable. Further is known also a rubber/plastic pair of loops, which is coupled to the wheel between two adjacent bolts, so that it is twisted into a detectable form when the nut slackens. This kind of rubber/plastic frame does not, however, resist to the loosening of the nuts/bolts and, especially, does not tighten them. In addition to this, it will only stand a few usage times and may fall off the wheel when it ages.

The publication U.S. Pat. No. 4,657,457 (Rickwood) has illustrated a locking device for nuts/bolts that is fitted between two nuts.

To connect the locking elements, a flexible element has been fitted, the structure of which, however, is not such that it could indicate clearly enough for example the slackening of a nut. A locking device of this type is suitable for use only in one size nut divisions. When installing the locking device, the flexible element must be adjusted between the elements, which makes the installing laborious when there are a lot of wheels. In that case, the locking is also very hard to install especially to twin wheel targets, where the nuts are “inside” the wheel rim. One important flaw in the locking device presented in this publication is particularly the lack of a tightening effect.

The object of the present invention is to develop a novel locking device that helps preventing the above-mentioned problems and furthers to reach secure and easy locking and tightening of a nut, as well as clear indication of the possible slackening of a nut. The characteristic features of a locking device of the present invention are listed in claim 1. The invention applies also to the corresponding installation device for the locking device, the characteristic features of which are listed in claim 9.

The locking device of the present invention is formed of at least three bracket elements that are chained with each other with a spring element and that simultaneously tighten nuts/bolts clockwise and indicate clearly their slackening.

According to one advantageous embodiment the locking device can be fabricated also as a closed loop. The locking device of the present invention is structurally simple and reliable. Further, it is very easy to use both when attaching and when detaching it, because the spring element supplied with it does not necessitate any particular setting actions.

The locking device of the present invention comprises also a installation device that facilitates the fitting and detaching of it even in difficult targets. Further, according to one embodiment, a protective lid can be fitted to the locking device to prevent the nut from getting dirty and stuck. Other characteristic features of the locking device of the present invention become evident in the accompanying claims and the description part.

The locking device of the present invention, which will not be limited to the embodiments illustrated in the following, will be explained more in detail by referring to the accompanying figures, wherein

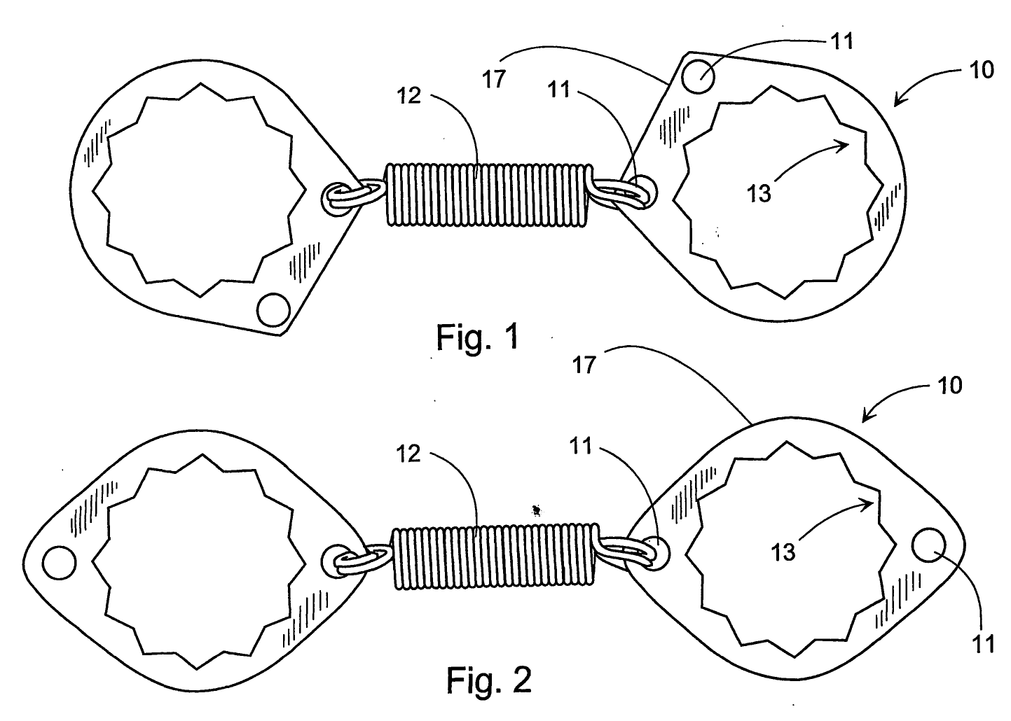

FIG. 1 illustrates a locking device for nuts of the present invention,

FIG. 2 illustrates another embodiment for the locking device of the present invention,

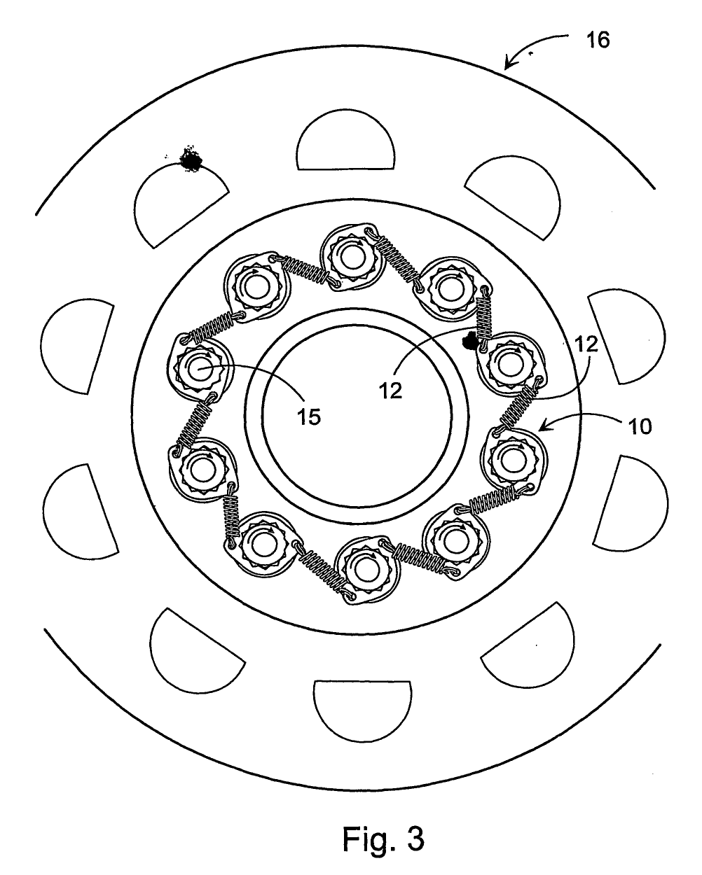

FIG. 3 illustrates the use of the embodiment illustrated in FIG. 2 to lock wheel nuts and to indicate their slackening,

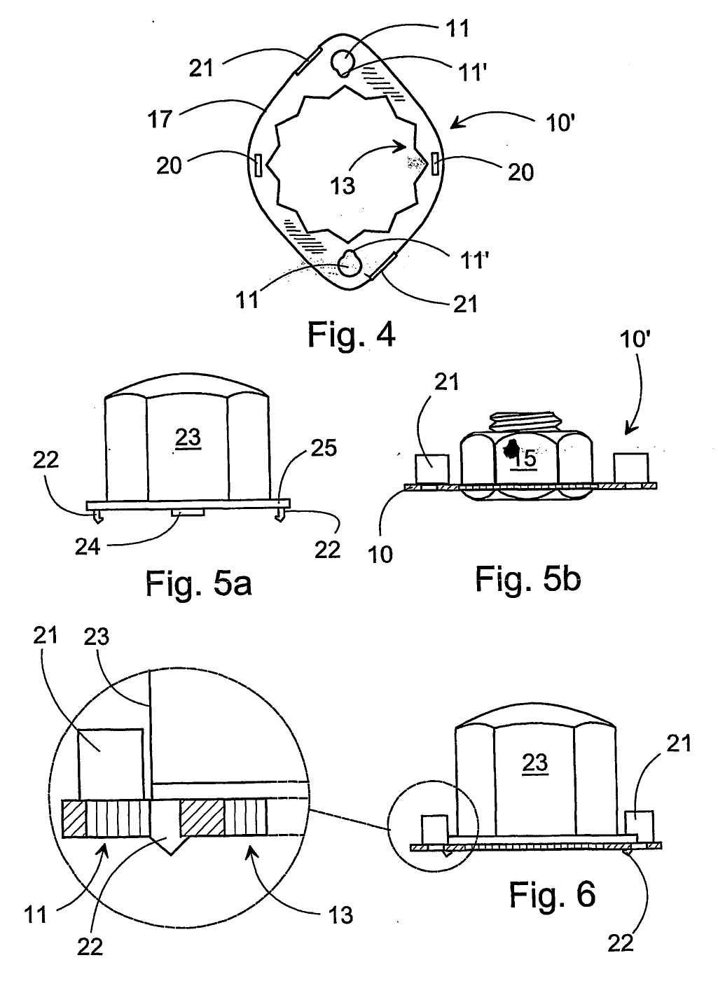

FIG. 4 illustrates a third example of a bracket used in a locking device of the present invention,

FIG. 5a illustrates an example of a protective lid to be fitted on a nut,

FIG. 5b illustrates the bracket in position seen from above,

FIG. 6 illustrates the protective lid illustrated in FIG. 5a fitted to the bracket illustrated in FIGS. 4 and 5b and

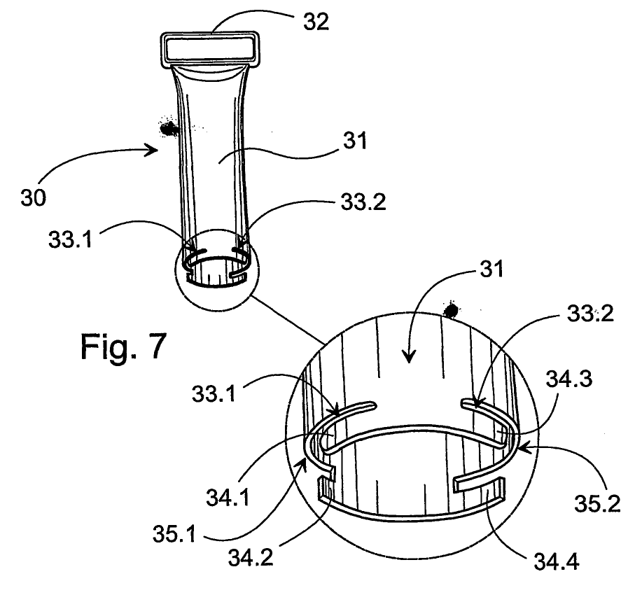

FIG. 7 illustrates an example of the installation device for the locking device.

FIG. 1 illustrates the first embodiment for the locking device for nuts of the present invention. The locking device to be fitted between nuts is formed by brackets 10 equipped with an inner race polygon 13. To the outer periphery 17 of the brackets 10 have been fitted two fastening cams 11 that can be used for example to fasten spring elements. There can be several fastening cams 11. The spring 12 will be fastened between the fastening cams 11 of two brackets 10. This embodiment of the bracket is suitable especially in industrial machines, where nuts laying on the same level may be situated in very irregular arrays with respect to each other. Some, however not restrictive, examples of such machines can be papermaking, metal working and printing machines (not illustrated).

In the second embodiment for the locking device for nuts illustrated in FIG. 2, the fastening cams 11 of the brackets 10 are on the opposite sides of the periphery 17 of the bracket 10 with respect to the bracket 10. In this case the form of the brackets 10 is slightly elliptical.

FIG. 3 illustrates a method of application for the locking device for nuts of the present invention especially as a fastener of a wheel. According to an advantageous embodiment, a closed loop is formed from brackets 10 equipped with an inner race polygon 13 and spring elements 12 between them, which is fitted, as illustrated in FIG. 3, on all the nuts 15 of the wheel 16. The fitting can be easily done even with bare manual power, if the convex side of the rim pivot points outwards. The torsion of the brackets 10 can be adjusted at will by means of an inner race polygon 13 and the spring 12 between two nuts 15 can be set into traction position. When the locking device is linked to a closed loop, every nut/bolt 15 of the wheel 16 are rotated substantially symmetrically on both sides.

Instead of the closed loop illustrated in FIG. 3, a locking device of the present invention can be formed of at least three brackets 10 linked to each other, between which is fitted a draw-spring 12. In this case at least one nut 15, which in the case of three brackets 10 is the one in the middle, will be tightened substantially symmetrically.

The values of the used draw-spring 12 are adjusted according to the spacing of the nuts of the wheel 16. If the nut 15 begins to slacken, the tightness of the draw-springs 12 fitted to both fastening cams 11 will increase, which opposes to the slackening. The time spent in examining the fastenings will decrease substantially, because the slackening of the nut 15 will be noticed at a quick glance, when the array illustrated in FIG. 3 gets broken.

The brackets 10 are manufactured advantageously of either common zinc coated FE52 steel plate or unfinished AISI/RST steel plate. A suitable plate thickness is for example 2 mm.

Due to the effect of the springback factor, the brackets 10 fasten tightly with their inside gear 13 to the nut 15, so they cannot fall off even when the vehicle is moving.

The inner race polygon 13 of the brackets 10 can contain for example 6, 12 (as in FIGS. 1-3) or 18 internal angles depending on the nut 15, for the locking and detection of the locking of which they are used. Generally, the locking device of the present invention can be implemented simply to all angle forms, to bolts and nuts 15 of all wrench sizes and all bolt/nut spacing and it is suitable also to a counter-thread through-bolt coupling.

The most advantageous spring element 12 between the cams 11 is for example an extension spring, but a spring element of another type may be possible. Even a variable or irregular nut spacing will not cause suitability problems in a case of a locking device realised with an extension spring.

FIG. 4 illustrates a third example of the bracket 10′ used in a locking device of the present invention. Here, on the outer periphery 17 of the bracket 10′ are the grips 21, which can be situated, as illustrated in FIG. 4, on the opposite sides of the bracket 10′ with respect to each other, near the fastening cams 11. The manual installing, removing and clamping of the locking device are facilitated by the grips 21 furnished for example by bevelling on the periphery 17 of the bracket 10′. The grips 21 also protect the fastening cams 11 and the spring element 12 fitted in contact with them from the spattering mud when used on wheels.

Further, to the bracket 10′ can be fitted also different fit elements, for example slots 20 or corresponding borings to attach the protective lid 23 of the nut 15 illustrated in FIG. 5a. In the boring of the fastening cam 11 there is a reaming 11′ towards the inner race 13 of the bracket 10′, which partly enables the attaching of the protective lid 23.

FIG. 5a illustrates an example of a protective lid 23 fitted on the nut 15. The protective lid 23 can be for example plastic and it can be shaped in the shape of a nut 15. A part of the protective lid 23 is for example the form elements 22, 24, fitted on the rim 25 of its open end, which are arranged so that when fitting the protective lid 23, they are directed at the fit elements 20, 11′ fitted on the bracket 10′. For the slots 20 in the lid 23 there are beaks 24 and for the reaming 11′ of the fastening cams 11 there are flexible hooks 22.

FIG. 5b illustrates the bracket 10′ in position seen from above and FIG. 6 the protective lid 23 fitted to the bracket 10′. The inset of FIG. 6 is an enlargement of the settling of the hook element 22 of the protective lid 23 to the fastening cam 11. The lid 23 locks in place in bracket 10′ when it is pressed on the nut 15, and when the fit elements 20, 11′ of the bracket 10′ and the form elements 22, 24 of the protective lid 23 are matched together. To loosen the lid 23, it is pressed sidewards towards either of the fastening cams 11, whereupon the hook 22 situated in the opposite direction with respect to the direction of the pressure sags and correspondingly, the hook 22 situated in the direction of the pressure can be pulled out of the fastening cam 11. In that case, the slots 20 situated in the bracket 10′ are slightly larger than their counterparts 24 situated in the lid 23.

FIG. 7 illustrates an example of the installation device 30 for the locking device, with which it can be installed particularly easily even to twin wheel targets, where the nuts 15 are known to be deep in the rim cup (not illustrated).

The installation device 30 comprises a cylindrical shaft 31, in the first end of which there is a handle 32 that functions as a hand grip. At the opposite end of the installation device 30, with respect to the handle 32, two cut-out slots 35.1, 35.2 at the opposite sides with respect to each other have been cut in the shaft 31. At the bottom of the cut-out slot 35.1, 35.2 in the shaft 31, two cross section slots 33.1, 33.2 opposite each other have been made, in which case four beaks 34.1-34.4 are formed at the end of the shaft 31. The section slots 33.1, 33.2 are within a distance from the other end of the shaft 32, where the said distance is determined by the size of the cut-out slots 35.1, 35.2. Further, the depth of the cross section slots 33.1, 33.2 of the shaft 31 is such that they are within a distance from each other.

In the following, the installing of the locking device with the installation device 30 on the wheel 16 illustrated in FIG. 3 will be described. At first, the brackets 10 of the locking device are fitted on the nuts 15 so that the spring elements 12 between them are not yet strained.

The installation device 30 is fit to the bracket 10, 10′ by first pushing the end with the section slots 33.1, 33.2 of the installation device 30 to the bracket 10, 10′ so that the fastening cams 11 of the bracket 10, 10′ are between the beaks 34.1, 34.2 and 34.3, 34.4, and the brackets 10, 10′ are at the bottom of the cut-out slot 35.1, 35.2.

When you start turning the installation device 30 counter-clockwise, the bracket 10′ is funnelled in the cross section slots 33.1, 33.2. When the turning is further continued, the periphery 17 of the bracket 10, 10′ arrives to match the end of the cross section slots 33.1, 33.2. After this, the bracket 10 can be pulled out of the nut 15 and the turning of the installation device 30 can be continued, in which case the spring elements 12 attached to the two fastening cams 11 are strained. The bracket 10, 10′ remains firmly attached to the installation device 30 because it is between the shaft 31 and the beaks 34.2, 34.3. When the installation device 30 is turned axially, the bracket 10, 10′ is turned according to the torsion of the installation device 30.

When the appropriate level of strain of the spring 12 has been reached, the bracket 10, 10′ will be pushed and fitted with the installation device 30 back to the nut 15, after which the installation device 30 can be turned clockwise, which releases the bracket 10, 10′ from between the beaks 34.2, 34.3 of the cross section slots 33.1, 33.2. The loosening of the locking device can be performed according to the corresponding principle.

The protective lid 23 of the nut 15 fitted to the locking device prevents the sticking of the nuts 15 because dirt, ice and splashes cannot get to affect the nut 15 and the threads. Further, also the falling off of a broken bolt can be prevented with a locking device of the present invention. The nuts 15 can be easily tightened even above the locking device, without removing it.

It is to be understood that the above explanation and the related figures are only meant to illustrate the locking device of the present invention on view. The invention has not thus been limited solely to the embodiments of presented above or defined in the claims, but the several different variations and versions that are possible within the frames of the inventive idea defined by the accompanying claims will be obvious to any specialist in the field.

1. Locking device for nut/bolt, which is a locking assembly to be positioned between at least two nuts/bolts (15), to which have been fitted at least two brackets (10, 10′) equipped with an inner race polygon (13), to the outer periphery (17) of which has been fitted a fastening cam (11) for the spring element (12) to be fitted between the brackets (10, 10′), characterised in that there are at least two of the said fastening cams (11) on the brackets (10, 10′) and that the said locking device is fitted to be formed of at least three brackets (10, 10′) chained with each other by spring elements (12), of which at least one is fitted to tighten the nut/bolt (15) of the target of fastening (16) symmetrically.

2. Locking device as defined in claim 1, characterised in that the said fastening cams (11) have been fitted on the outer periphery (17) of the bracket (10, 10′) on the opposite sides with respect to the said bracket (10, 10′).

3. Locking device as defined in claim 1 or 2, characterised in that the said brackets (10, 10′) with the spring elements (12) between them have been fitted to form a closed loop to attach all the nuts/bolts (15) of the target of fastening (16).

4. Locking device as defined in claims 1-3, characterised in that the inner race polygon (13) of the brackets (10, 10′) is formed of 6, 12 or 18 internal angles.

5. Locking device as defined in any one of claims 1-4, characterised in that there are fitting elements in the bracket (10′), such as slots (20) or similar (11′), to attach the protective element (23) of the nut/bolt (15) in contact with it.

6. Locking device as defined in claims 1-5, characterised in that the spring element is formed of a extension spring (12) common as such.

7. Locking device as defined in any one of claims 1-6, characterised in that one or more grip elements (21) have been furnished to the bracket (10′) to facilitate the installing of it.

8. Locking device as defined in any one of claims 1-7, characterised in that the locking device comprises a installation device (30) consisting of a shaft (31) and cuttings and/or slots (33.1, 33.2, 35.1, 35.2,) furnished at one end of it, to which the bracket (10, 10′) can be fitted by its outer periphery (17).

9. Installation device (30) for the locking device, which comprises brackets (10, 10′) and spring elements (12) fitted between them, characterised in that the locking device (30) comprises cuttings and/or slots (33.1, 33.2, 35.1, 35.2,) that can be fitted to the outer periphery (17) of the bracket (10, 10′) to install, tighten and remove the locking device.
